(19) United States
(12) Patent Application Publication
(10) Pub. No.: US 2006/0215620 A1
(43) Pub. Date: Sep. 28, 2006

(54) Advanced WLAN access point and a message processing method for the same

(75) Inventors: Jui-Long Ou, Hsin-Chu (TW); Hsiao-Shun Jan, Hsin-Chu (TW); Ching-Fu Teng, Hsin-Chu (TW); Maujy Peng, Hsin-Chu (TW)

Correspondence Address: TROXELL LAW OFFICE PLLC;SUITE 1404, 5205 LEESBURG PIKE, FALLS CHURCH, VA, 22041, US

(73) Assignee: Z-COM, INC.

(21) Appl. No.: 11/086,341

(22) Filed: Mar. 23, 2005

(51) Int. Cl. H04J 3/00

(52) U.S. Cl. 370/338

(57) ABSTRACT

An advanced WLAN access point and a message processing method for the same is disclosed. The access point includes a time division multiplex (TDM) processing unit employed to process a TDM message from a broadband network. Moreover, a data processing unit used to process the data message is introduced, and a field-programmable gate array (FPGA) is used to transform a high-speed message into a standard data packet from the TDM processing unit and the data processing unit as well. Then the standard data packet is transmitted to a WLAN module. During the transmission procedure, the received message is transformed into a standard data packet through the advanced WLAN access point. Thereafter, the message is divided into a data message and a TDM message by the FPGA, and is outputted via their corresponding devices. The access point disclosed in the present invention monitors and configures the parameters thereof.

### BACKGROUND OF THE INVENTION

1. Field of the Invention

An advanced WLAN access point and message processing method thereof is disclosed and, more particularly, the access point is applied to a wireless LAN, data processing and time division multiplex technology.

2. Description of Related Art

Wireless local area network (WLAN) devices are now developed communication products, mainly used to transmit data messages. In accordance with current time division multiplex technology (which is applied to a communication system, for example), the voice time division multiplex message from a broadband network can be transmitted through the WLAN after a proper transformation.

FIG. 1 illustrates a schematic diagram of the processing structure of both a voice packet and a data packet, where a time division multiplex (TDM) message is usually applied to the voice communication. A client integrated access point 13 of the prior art integrates the voice packet and the data packet, by which the user can transmit voice and data simultaneously. Thereof, the voice message can be produced using a telephone 11, and transmitted to a network adapter 14 by the client integrated access point 13. The data packet produced by a computer 12 is transmitted to the client integrated access point 13, and then transmitted to the network adapter 14. Thereby, the network adapter 14 carries the voice and data packet at the same time. Thereafter, the voice packet goes to a PSTN (Public Switched Telephone Network) 17 through a voice PBX 15, and the data packet goes to the Internet 18 through an Internet Service Provider (ISP) 16.

As the receiving state of the access point 13, the network adapter 14 receives the voice and data message through the voice PBX 15 and the ISP 16 respectively. After the transformation, the voice and data message are divided and received by the corresponding devices.

The communication device used in the prior art provides an adapter for the voice and the Ethernet device. If the wireless transmission is adopted, the Ethernet device therein connects with the wireless local area network. However, the connection device used over the voice and date message is very expensive and inconvenient to use. Furthermore, the product introduced there between cannot provide an integrated mechanism due to the different transmission protocols between every network and, more particularly, the product cannot handle the simultaneous transmission of a TDM message and a data message, resulting in a failure to control transmission quality.

In view of the aforementioned drawback of the prior art, the present invention provides an advanced WLAN access point, which is installed on a printed circuit board (PCB). Whereby a TDM message and a data message are identified because the transmission route is changed, and transmission quality remains high. The access point includes the following functions:

In baseband:
a. An Input/Output interface function, which provides an interface for time division multiplex messages and data messages.
b. A circuit test function, which includes the Far/Near End Loop Test of a TDM module and an Ethernet.
c. An efficiency test function, which is the bit error rate test for a TDM module and an Ethernet.
d. A packet calculating function, which detects a packet's size in the Ethernet and enhances transmission rate.
e. The access point is manufactured according to IEEE802.11 standard.

### SUMMARY OF THE INVENTION

Broadly speaking, an advanced WLAN access point includes a time division multiplex (TDM) processing unit, which processes the TDM message received from a broadband network; a data processing unit, which is used to process a data message; a field-programmable gate array (FPGA), which is used to transform the message from the TDM processing unit and the data processing unit into a standard data packet; a WLAN module, which transforms the packet into a RF message, and transmits the RF message out afterward; and a processor that monitors the operation of the access point. Otherwise, the aforementioned packet message goes through the WLAN access point and forms the standard data packet in the receiving process, then, the packet is transmitted using the corresponding devices.

The message processing method of an advanced WLAN access point includes receiving a TDM message and a data message. The TDM message and the data message are then transformed into a standard data packet. The packet is then transmitted to a processor, and finally the RF message is formed and transmitted out.

The receiving steps thereof include: receiving a RF message by an antenna electrically connected with the access point, and transmitting the message to a WLAN module. The message passes through wave filtering, is amplified and transformed into a digital message. The RF message is then transmitted to a processor, in which the processor monitors the bit error rate (BER) of the TDM data of the access point, and divides the RF message, which is transmitted to a FPGA. Therefore, the TDM message and the data message are divided and received by the TDM processing unit and the data processing unit, and the message is restored and received.

### BRIEF DESCRIPTION OF THE DRAWINGS

The present invention will be readily understood by the following detailed description in conjunction with the accompanying drawings, in which:

FIG. 1 is a schematic diagram of the procedure for processing a voice packet and a data packet of the prior art;

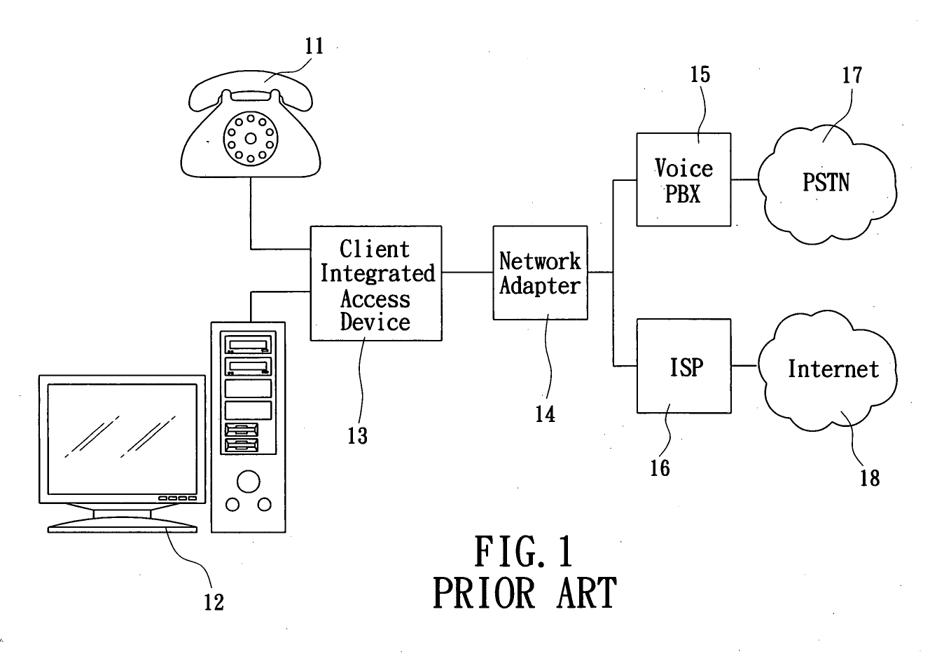

FIG. 2 is a schematic diagram of the embodiment of the advanced WLAN access point of the present invention;

FIG. 3 is a flowchart of the process for transmitting a message to the advanced WLAN access point; and

FIG. 4 is a flowchart of the process for receiving a message from a advanced WLAN access point.

### DETAILED DESCRIPTION OF PREFERRED EMBODIMENTS

To allow the Examiner to understand the technology, means and functions adopted in the present invention further, reference is made to the following detailed description and attached drawings. The Examiner shall readily understand the invention deeply and concretely from the purpose, characteristics and specification of the present invention. Nevertheless, the present invention is not limited to the attached drawings and embodiments in the following description.

An advanced WLAN access point is introduced to process a time division multiplex (TDM) message and a data message simultaneously, so as to provide complete voice and data management and handle simultaneous transmission of a TDM message and a data message. Since the access point is installed on a printed circuit board, the TDM message and the data message therein are processed and identified simultaneously, and transmission quality remains high. Furthermore, an Input/Output interface for the TDM message and the data message is provided; a Far/Near End Loop Test of a TDM module and an Ethernet are introduced and also a bit error rate (BER) test thereof is provided; a packet size calculating function is included in the access point to enhance the transmission rate. Finally, an access point is manufactured according to IEEE802.11 standard.

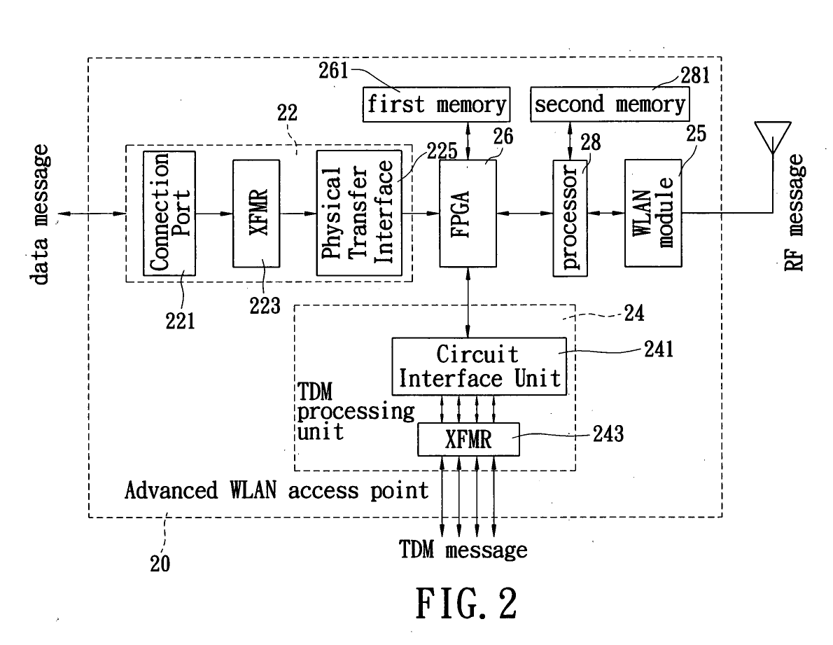

FIG. 2 shows the preferred embodiment of the present invention. The advanced WLAN access point 20 comprises:

A field-programmable gate array (FPGA) 26 electrically connected with a data processing unit 22 and a TDM processing unit 24 in the advanced WLAN access point 20. The access point 20 transforms the high-speed message received from the data processing unit 22 and the TDM processing unit 24 into a standard data packet format. The field-programmable gate array 26 is further electrically connected with a first memory 261, in which the message is temporarily stored.

The TDM processing unit 24 receives a message through a second XFMR 243 and a circuit interface unit 241 thereof The TDM message, such as a voice message, is then received from a broadband network and processed. Moreover, the TDM processing unit 24 monitors the Near End Loop Test, the Far End Loop Test and the Bit Error Rate (BER).

The data processing unit 22 includes a connection port 221, such as a RJ-45 or a USB interface, connecting with an external data message. A first XFMR 223 and a physical transfer interface 225 are also included to receive the data message and then transmit the received message to the FPGA 26 after it is processed. Moreover, the data processing unit 22 can perform a Near End Loop Test and a Far End Loop Test.

A WLAN module 25 of the preferred embodiment electrically connects with the advanced WLAN access point 20 of the present invention. The WLAN module 25 transforms the aforementioned message into a RF message and the RF message is transmitted via an antenna. Alternatively, the antenna receives the RF message, and transforms that message into a digital message. The digital message is then transmitted to a processor 28. The processor 28 processes the received digital message, and the second memory 281 therein is the buffer memory for the digital message in the meantime. Finally, the digital message is transmitted to the WLAN module 25 and the FPGA 26.

The digital message is received by the WLAN module 25 and processed by the FPGA 26. The message is then divided into a TDM message and a data message. The TDM message and the data message are then individually transmitted to the TDM processing unit 24 and the data processing unit 22. Finally, each message is received by the corresponding device.

The advanced WLAN access point 20 of the preferred embodiment of the present invention is a platform for a WLAN access point with an IEEE802.11 standard, and is manufactured with the required hardware and product management software. Moreover, the voice time division multiplex (TDM) message from the broadband network (e.g. E1/DS1/J1) is transmitted to the circuit interface unit 241 via the second XFMR 243, and is processed into a high-speed message stream, which is transmitted to the FPGA 26. Alternatively, the data message can go to the FPGA 26 through the connection port 221, the first XFMR 223 and the physical transfer interface 225.

The TDM message with a voice message is processed in the FPGA 26, and wrapped up together as a data packet message according to the frame format protocol of the Ethernet. Therein, the data message, which comprises a local address, a destination address, a message priority, etc., is transmitted to an output buffer of the FPGA 26 as the coupled first memory 261 shown in the diagram. After the data message is transmitted to a FPGA 26, the payload of the retrieved message stream is scrambled to encrypt the message. Next, a plurality of the original controlling messages are wrapped up together, and a complete packet message is formed.

Afterward, the complete packet message is transmitted to an output buffer, such as a second memory 281 of the FPGA 26. Due to the real-time requirements of the TDM message, the TDM message packet has a higher output priority than a data message packet since a TDM message should not be delayed. After that, the packet message is outputted to the processor 28 and forms a RF message through the WLAN module 25. Finally the message is transmitted by an antenna.

Because the RF message received by the antenna is often weak, the message is received by the WLAN module 25 and amplified through wave filtering. Then the analogy RF message is transformed into a digital message, and the message is wrapped up together as a standard packet and transferred to the processor 28. Next, the message is transmitted to the FPGA 26 and divided into a TDM message and a data message. After the TDM message and the data message are de-scrambled in a decrypting process, the message is transmitted to the TDM processing unit 24 and the data processing unit 22 separately. Later, the TDM message and the data message are restored to their original form after the process outlined in the paragraph above.

The processor 28 herewith is used to monitor the processing status of the access point of the present invention, including the bit error rate (BER) of the time division multiplex of the advanced WLAN access point and to report any failures. The processor 28 can perform a Far End Loop Test and a Near End Loop Test as well. Another function of the processor 28 is to connect with a terminal machine via a physical connection, and show the result of the input/output message on the display.

The following steps describe the method for processing the message of the advanced WLAN access point of the present invention. The steps therein are included in both the transmitting and the receiving processes.

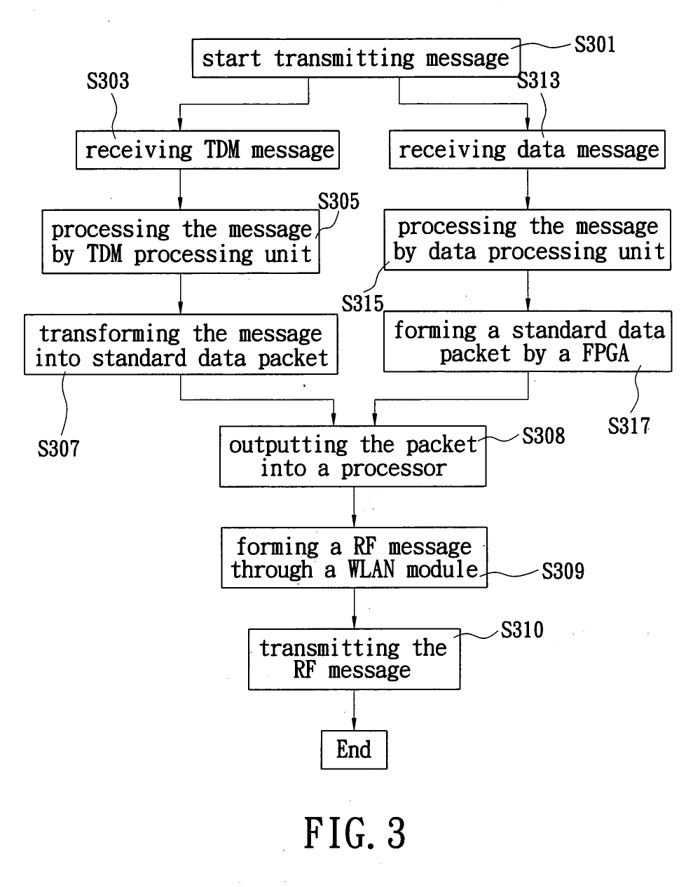

FIG. 3 shows a flowchart for the transmitting process of the preferred embodiment of the present invention. The modules of the present invention are installed on the same circuit board to change the transmission route. The TDM message and the data message are identified simultaneously. In the beginning, the message is transmitted (step S301). The advanced WLAN access point receives an external TDM message, such as a voice message (step S303). The TDM processing unit therein processes the received message, and transforms the message into a high-speed message stream (step S305). After that, the high-speed message is received by the FPGA and transformed into a standard data packet, and saved in the first memory (step S307). Alternatively, the advanced WLAN access point can receive the data message (step S313). The data message is then processed by the data processing unit (step S315), and forms a standard data packet by the FPGA, and saved in the first memory after a scrambling process (step S317).

Each message mentioned in the preceding paragraph is outputted from the FPGA to the processor (step S308). In step S309, the message forms a RF message through the WLAN module (step S309). Finally, the transmission is completed (step S310).

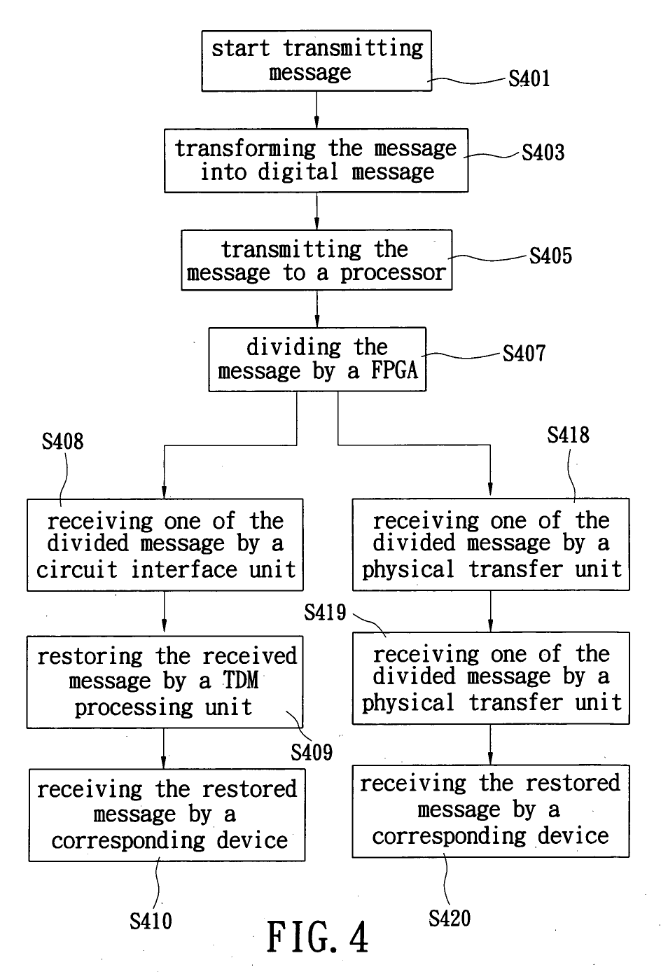

FIG. 4 shows the flowchart of the receiving process of the preferred embodiment of the present invention.

In the beginning of the receiving process, the antenna connected with the access point of the present invention receives the RF message (step S401). After the RF message is received by the WLAN module, the analog RF message is transformed into a digital message by wave filtering and amplifying (step S403). The digital message is in standard data packet format, and is transmitted to the processor (step S405). The digital message is transmitted to the FPGA, and divided into a TDM message and a data message. The TDM message is then transmitted to the TDM processing unit and the data message is transmitted to the data processing unit separately after the de-scrambling process (step S407). The TDM message is then received by a circuit interface unit of the TDM processing unit (step S408). The TDM message is restored, just as the voice message is restored (step S409) and the restored message is received by a corresponding device, such as telephone (step S410).

However, the data message is received by a physical transfer interface of the data processing unit (step S418). In the step S419, the data message is restored, and received by a corresponding device, such as a computer or a related digital message processing device (step S420).

The method of the advanced WLAN access point of the present invention achieves an integrated message management and good TDM message transmission quality. Wherein, the WLAN, data process, and TDM process are included, and the specific function of the access point disclosed in the present invention can monitor and configure the parameters thereof. More essentially, the WLAN module, the data processing unit and the TDM processing unit are integrated into a single circuit board; the transmission route can be changed thereby, and the TDM message and the data message can be identified simultaneously.

The many features and advantages of the present invention are apparent from the written description above and it is intended by the appended claims to cover all. Further, since numerous modifications and changes will readily occur to those skilled in the art, it is not desired to limit the invention to the exact construction and operation as illustrated and described. Hence, all suitable modifications and equivalents may be resorted to as falling within the scope of the invention.

What is claimed is:

1. An advanced WLAN (wireless local area network) access point, comprising:
a field-programmable gate array (FPGA) used to transform a time division multiplex (TDM) message and a data message received from the access point into a standard data packet, or used to divide the data packet into the TDM message and the data message;
a time division multiplex processing unit electrically connecting with the field-programmable gate array, and used to process the received TDM message thereby;
a data processing unit electrically connecting with the field-programmable gate array, and used to process the data message;
a processor electrically connecting with the field-program gate array, and used to process digital messages, the processor monitors a bit error rate (BER) of the time division multiplex of the advanced WLAN access point, the processor further performs a Far End Loop Test and a Near End Loop Test; and
a WLAN module electrically connecting with the processor, and used to transform the standard data packet into a radio frequency (RF) message, or used to transform the received RF message into a standard data packet.

2. The access point as recited in claim 1, wherein the data processing unit includes a physical transfer interface, a first physical interface transform device and a connecting port, and receives the data message via the connecting port therein.

3. The access point as recited in claim 1, wherein the TDM processing unit includes a circuit interface unit and a second physical interface transform device.

4. A message processing method for an advanced WLAN (wireless local area network) access point, wherein a TDM processing unit and a data processing unit of the access point are used to process a TDM message and a data message respectively, and a field-programmable gate array (FPGA) is used to transform the message and change a transmission route, the method comprises steps:
receiving the TDM message and the data message through the TDM processing unit and the data processing unit of the advanced WLAN access point respectively;
transforming the TDM message and the data message into a standard data packet through the FPGA;
transmitting the standard data packet to a processor;
forming a radio frequency (RF) message via a WLAN module; and
transmitting the RF message.

5. The message processing method as recited in claim 4, wherein the step of the standard data packet transformation, a complete packet is formed through the FPGA after a de-scrambling process.

6. The message processing method as recited in claim 4, wherein the TDM processing unit performs a Far End Loop Test and a Near End Loop Test, or monitors a bit error rate (BER).

7. The message processing method as recited in claim 4, wherein the data processing unit performs a Far End Loop Test and a Near End Loop Test.

8. The message processing method as recited in claim 4, wherein the processor is used to monitor a bit error rate of the TDM message at the access point.

9. The message processing method as recited in claim 4, wherein the processor performs a Far End Loop Test and a Near End Loop Test.

10. The message processing method as recited in claim 4, wherein the advanced WLAN access point is capable of calculating a packet size.

11. A message processing method for an advanced WLAN (wireless local area network) access point, wherein a field-programmable gate array (FPGA) is used to divide a time division multiplex (TDM) message processed by a TDM processing unit and a data message processed by a data processing unit, and used to change a transmission route, the method comprises steps:
receiving a radio frequency (RF) message by an antenna electrically connected with the access point;
transmitting the RF message to a WLAN module, the message passes through wave filtering, amplifying and is transformed into a digital message;
transmitting the RF message to a processor, the processor monitors a bit error rate (BER) of the TDM data of the access point.
dividing the RF message, then transmitting the RF message to the field-programmable gate array, thereby dividing the TDM message and data message;
receiving the TDM message and data message, wherein the TDM message is received by the TDM processing unit and the data message is received by the data processing unit;
restoring the message from the TDM message and the data message; and
receiving the restored message.

12. The message processing method as recited in claim 11, wherein the divided RF message is transmitted to the TDM processing unit and the data processing unit after a de-scrambling process.

13. The message processing method as recited in claim 11, wherein the data message is received by a physical transfer interface of the data processing unit.

14. The message processing method as recited in claim 11, wherein the TDM message is received by a circuit interface unit of the TDM processing unit.

15. The message processing method as recited in claim 11, wherein the TMD processing unit performs a Near End Loop Test.

16. The message processing method as recited in claim 11, wherein the TMD processing unit performs a Far End Loop Test.

17. The message processing method as recited in claim 11, wherein the TMD processing unit monitors a bit error rate.

18. The message processing method as recited in claim 11, wherein the data processing unit performs a Near End Loop Test and a Far End Loop Test.

19. The message processing method as recited in claim 11, wherein the processor performs a Near End Loop Test and a Far End Loop Test.

20. The message processing method as recited in claim 11, wherein the advanced WLAN access point is capable of calculating a packet size.
